(19) United States
(12) Patent Application Publication
(10) Pub. No.: US 2022/0026019 A1
(43) Pub. Date: Jan. 27, 2022

(54) LUBRICATING CAN

(71) Applicants: Nuevo Products Development Co., Ltd., Changhua City (TW); Yo Lee Auto co., Ltd., Tainan City (TW)

(72) Inventors: Chao-Ching TSENG, Changhua City (TW); Kun-Wang WANG, Tainan City (TW)

(21) Appl. No.: 16/938,240

(22) Filed: Jul. 24, 2020

(51) Int. Cl. F16N 3/10; F16N 19/00; F16N 11/02; F16C 33/66

(52) U.S. Cl. CPC F16N 3/10; F16C 33/6607; F16N 11/02; F16N 19/00

(57) ABSTRACT

A lubricating can has a grease cup, bolt, piston, pressing base, bearing placement portion and a rotation driving component. The fixed end of the bolt is fixed on the grease cup bottom. The piston is housed inside the lubricating trough. The piston has a pressing surface, a bearing surface and a lateral ring surface that is tightly fitted on and can slide along the inner wall. The center of the piston is formed with a through hole and a plurality of lubricating guide holes. The through hole is sheathed on the bolt. The lower end pressing portion of the pressing base has a screw hole to fit the bolt. The bearing placement portion is defined and formed by the space between the lower end pressing portion and the bearing surface of the piston. The rotation driving component is configured on the upper end bearing portion of the pressing base.

### CROSS-REFERENCE TO RELATED U.S. APPLICATIONS Not applicable.

### STATEMENT REGARDING FEDERALLY SPONSORED RESEARCH OR DEVELOPMENT

Not applicable.

### NAMES OF PARTIES TO A JOINT RESEARCH AGREEMENT Not applicable.

### REFERENCE TO AN APPENDIX SUBMITTED ON COMPACT DISC Not applicable.

### BACKGROUND OF THE INVENTION

### 1. Field of the Invention

The present invention relates generally to a lubricating device for bearings, and more particularly to an innovative structural design of a lubricating can.

### 2. Description of Related Art Including Information Disclosed Under 37 CFR 1.97 and 37 CFR 1.98

During usage, the roller unit in the structure of a bearing is subject to frequent rolling friction and pressure. Therefore, lubrication is an important procedure. At present, industrial lubricating grease is commonly used as the lubricant for bearing roller units. Under normal temperatures, the industrial lubricating grease looks like paste. If the lubricating grease is gradually filled into the bearing roller unit by hand, it takes a lot of time and labor and the lubricating quality can not be perfectly controlled. In view of the above problem, some manufacturers have developed some kinds of bearing lubricating grease filling device, shaped like a can. However, such existing devices still have some problems and drawbacks. Examples are as follows.

“Means for packing bearings” is disclosed in U.S. Patent Document U.S. Pat. No. 1991542. In this prior art, the grease cup comprises a cup body and a cup cover combined together. The cover body has a cone-shaped funnel for selective placement of bearings of different outer diameters. Inside the cup body, a piston is configured to slide up and down. The space formed between the piston and the cone-shaped funnel above is to hold lubricating grease. The center of the piston is connected with a bolt. The top end of the bolt extends upward above the aforesaid cone-shaped funnel and the bearing. The top end of the bolt is combined with a pressing base. Above the pressing base, there is a nut. The nut is screwed on the bolt. Based on such a structure, when the nut rotates clockwise, the bolt will go upward under the guidance of the tilted threads and subsequently drives the piston to rise. At this time, the lubricating grease will be squeezed upward, and be filled into the bearing structure. However, in real applications, such kind of prior-art structure still has some problems. For example: the grease cup must be configured in the form of two components with a cup body and a cap body. The structure is quite complicated. According to the patent, the cone shape of the funnel is a necessary design for pressing the external ring frame of the bearing, so as to block the lubricating grease and force it to go to the rollers and into the gaps between the internal and external ring frames of the bearing. The funnel must be made into a cone shape and must have sufficient thickness to bear the pressure from the bearing. Therefore, the production cost is high. In addition, when the user rotates the nut to lubricate, the distance between the nut and the piston to be driven is almost equal to the whole length of the bolt (actually more than 20 centimeters). Thus, when rotating the nut, the counter forces to be overcome include the weight of the bolt, the weight of the piston, and the weight of the whole lubricating grease. Hence, such a structure is difficult and inconvenient to operate.

U.S. Patent Document U.S. Pat. No. 2,515,208 discloses a “Wheel bearing packer”. The main structure of this prior art is similar to the above one. Therefore, it still has the drawback of high production cost and inconvenient operation.

In addition, U.S. Patent Document U.S. Pat. No. 6,520,292 discloses a “bearing lubricating grease filling device”. In this prior art, a bearing clamp fixing device is configured inside the grease cup and is capable of moving up and down. Between the bearing clamp fixing device and the cup bottom of the grease cup, a lubricating grease filling space is defined and formed. The top surface of the bearing clamp fixing device is formed with a bearing placement surface. The center of the bearing clamp fixing device is formed with a grease filling passage that goes through vertically. When a bearing is placed on the bearing placement surface, the downward pressing mechanism configured above can be operated by the user to press down the bearing together with the bearing clamp fixing device, forcing the lubricating grease inside the grease filling space to go upward through the aforesaid passage and into the bearing. However, in real applications, problems are still found in this prior art. The lubricating function can only be accomplished by manually pressing the downward pressing mechanism with a hand. However, as the lubricating grease is usually paste-like industrial lubricant having very poor liquidity, the user has to apply a massive force to cause slight flow of the lubricating grease. Therefore, the operation takes a lot of labor and time, and is very inconvenient. If pressing tools like vises are used for pressing, the lubricating procedure becomes more complicated and takes higher cost. These problems must be overcome.

### BRIEF SUMMARY OF THE INVENTION

The main object of the present invention is to provide a lubricating can, aiming to solve the technical problems by making a breath through in the development of a practically ideal new-style lubricating can. The lubricating can is specially designed to help users fill paste-like lubricating grease into the roller unit structure of a bearing. The bearing has an axle hole and an external frame and the lubricating can comprises a grease cup, a bolt, a piston, a pressing base, a bearing placement portion, and a rotation driving component.

Based on the above object, the problem-solving technical features of the present invention are as follows: The grease cup has a closed cup bottom, an open cup mouth, and a cylindrical inner wall between the cup bottom and the cup mouth. The inside of the grease cup defines and forms a lubricating trough. The lubricating trough is used to hold the lubricating grease. The bolt is fixed inside the lubricating trough. The bolt comprises a fixed end and an extension end, wherein, the fixed end is connected and fixed in the center of the cup bottom, and the extension end extends toward the cup mouth for a preset length. The bolt is formed with guiding threads. The piston is housed inside the lubricating trough, capable of moving up and down under a force. The piston has a pressing surface and a bearing surface opposite each other, and a lateral ring surface connecting the peripheries of the pressing surface and the bearing surface, wherein, the bearing surface faces upward toward the cup mouth, and the pressing surface faces downward toward the cup bottom. The pressing surface is to press the lubricating grease held inside the lubricating trough. The lateral ring surface is configured with at least one ring seal. The at least one ring seal and the cylindrical inner wall are tightly pressed against each other in a slidable fashion. The center of the piston is formed with a through hole that goes through the pressing surface and the bearing surface. The through hole is sheathed on the bolt from the extension end of the bolt, and the through hole fits the bolt loosely, so that, relatively, the piston is not driven by the bolt. Furthermore, the piston is formed with a plurality of lubricating guide holes on the periphery of the through hole, lined up in a circle with intervals. A plurality of lubricating guide holes go through the pressing surface and the bearing surface. The pressing base comprises an upper end bearing portion and a lower end pressing portion, wherein, in the center of the lower end pressing portion, a screw hole is formed upward. The screw hole fits the guiding threads formed on the bolt. The lower end pressing portion faces the bearing surface of the piston. The upper end bearing portion is located above the cup mouth of the grease cup mouth. The bearing placement portion is defined and formed by the space between the lower end pressing portion of the pressing base and the bearing surface of the piston. The bearing placement portion is for placement of the bearing. The lower end pressing portion of the pressing base presses downward and seals the axle hole of the bearing. The external frame of the bearing presses downward on the bearing surface of the piston, and defines and forms a closed lubricating margin. The rotation driving component is configured on the upper end bearing portion of the pressing base. The rotation driving component can rotate when the user applies a force, and can drive the pressing base to rotate and move up and down.

The main efficacies and advantages of the present invention are as follows:

First, the structural design is simplified: comparing to the complicated structure of the prior art described above, which comprises two components (the cup body and the cap body) and a cone-shaped funnel, the grease cup of the lubricating can disclosed in the present invention features the combination of cylindrical inner wall and an open cup mouth, thereby considerably simplifies the structural design. As a result, the production and processing cost can be substantially reduced to offer better industrial and economic efficiency.

Second, the operation is less labor-consuming and more efficient: comparing to the problem of labor-consuming and inconvenient operation of the prior art, the lubricating can disclosed in the present invention provides an ideal grease filling driving mechanism, wherein, the bolt is fixed inside the grease cup and can not move, the user turns the rotation driving component to drive the pressing base to rotate and press down the bearing and piston to squeeze the lubricating grease into the bearing. During the process, the bearing, piston and pressing base all generate simultaneous downward forces because of their individual weight. Therefore, such operating components all generate contributing forces instead of reacting forces. As a result, when the user applies a force to operate the rotation driving component, the resistance is minimized, and the operation becomes easier and more efficient. This is the advantage and practical advancement of the present invention.

### BRIEF DESCRIPTION OF THE SEVERAL VIEWS OF THE DRAWINGS

FIG. 1 is a combined perspective view of a preferred embodiment of the present invention of a lubricating can.

FIG. 2 is an exploded perspective view of a preferred embodiment of the present invention of a lubricating can.

FIG. 3 is an exploded sectional view of a preferred embodiment of the present invention of a lubricating can.

FIG. 4 is a combined sectional view of a preferred embodiment of the present invention of a lubricating can.

FIG. 5 is a lubricating operational view of a preferred embodiment of the present invention of a lubricating can.

FIG. 6 is an enlarged view of Notation 6 in FIG. 5.

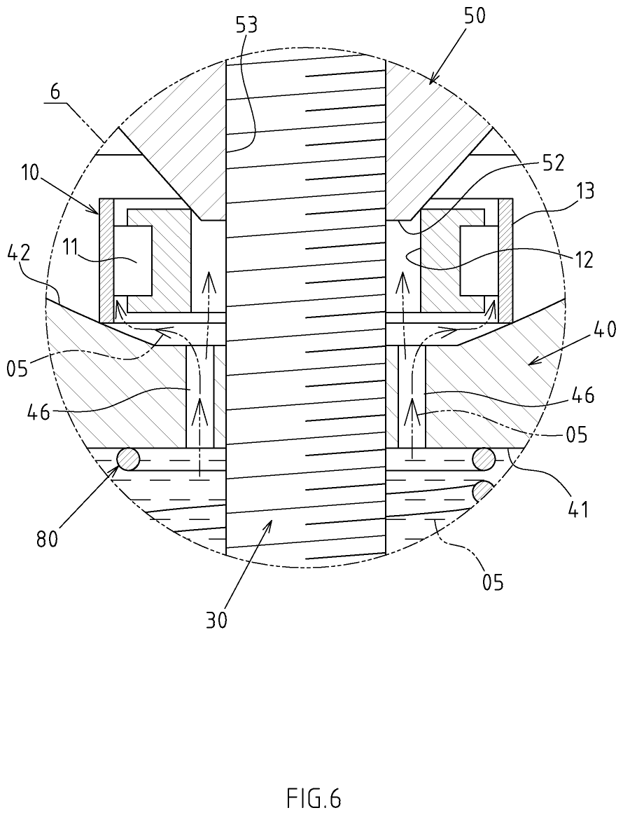

### DETAILED DESCRIPTION OF THE INVENTION

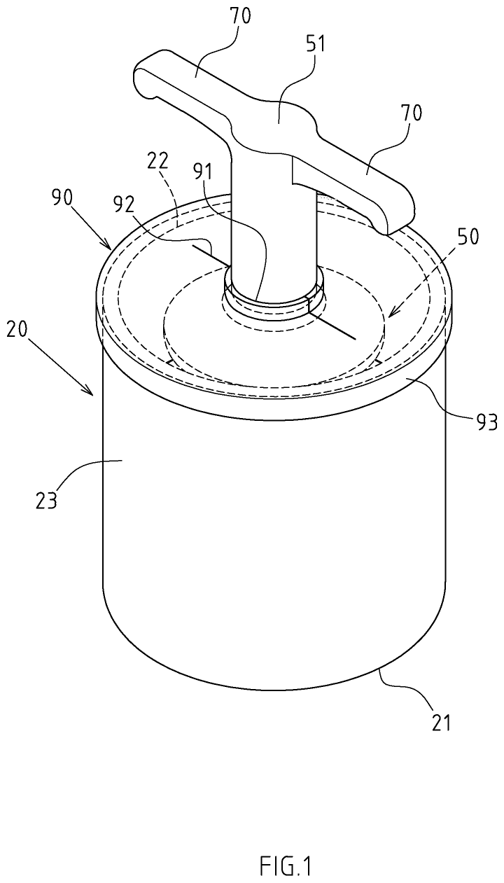

Referring to FIG. 1 to FIG. 4, a preferred embodiment of the present invention of a lubricating can is disclosed.

The lubricating can is specially designed to help an user to inject paste-like lubricating grease 05 (normally an industrial lubricant) into the roller unit 11 of a bearing 10. The bearing 10 has an axle hole 12 and an external frame 13. The lubricating can comprises a grease cup 20, a bolt 30, a piston 40, a pressing base 50, a bearing placement portion 60 and a rotation driving component 70.

In particular, the grease cup 20 has a closed cup bottom 21, an open cup mouth 22 and a cylindrical inner wall 23 between the cup bottom 21 and the cup mouth 22. The inside space of the grease cup 20 forms a lubricating trough 24. The lubricating trough 24 is used to hold the lubricating grease 05.

The bolt 30 is fixed inside the lubricating trough 24. The bolt 30 comprises a fixed end 31 and an extension end 32, wherein, the fixed end 31 is fixed on the center of the cup bottom 21, and the extension end 32 is extended toward the cup mouth 22 for a preset length. The bolt 30 is formed with guiding threads 33.

The piston 40 is housed inside the lubricating trough 24 and can move up and down under a force. The piston 40 has a pressing surface 41 and a bearing surface 42 opposite each other, and a lateral ring surface 43 connecting the peripheries of the pressing surface 41 and the bearing surface 42. In particular, the bearing surface 42 faces upward toward the cup mouth 22, and the pressing surface 41 faces downward toward the cup bottom 21. The pressing surface 41 is to press the lubricating grease 05 held in the lubricating trough 24. The lateral ring surface 43 is configured with at least one ring seal 44. The at least one ring seal 44 and the cylindrical inner wall 23 are pressed against each other in a slidable fashion. The center of the piston 40 is formed with a through hole 45 that goes through the pressing surface 41 and the bearing surface 42. The through hole 45 is sheathed on the bolt 30 from the extension end 32 of the bolt 30, and the through hole 45 fits the bolt 30 loosely, so that, relatively, the piston 40 is not driven by the bolt 30. The piston 40 is formed with a plurality of lubricating guide holes 46 on the periphery of the through hole 45, lined up in a circle with intervals. The plurality of lubricating guide holes 46 go through the pressing surface 41 and the bearing surface 42.

The pressing base 50 comprises an upper end bearing portion 51 and a lower end pressing portion 52, wherein, in the center of the lower end pressing portion 52 (Note: in a tapered shape), a screw hole 53 is formed upward. The screw hole 53 fits the guiding threads 33 formed on the bolt 30. The lower end pressing portion 52 faces the bearing surface 42 of the piston 40. The upper end bearing portion 51 is located above the cup mouth 22 of the grease cup 20.

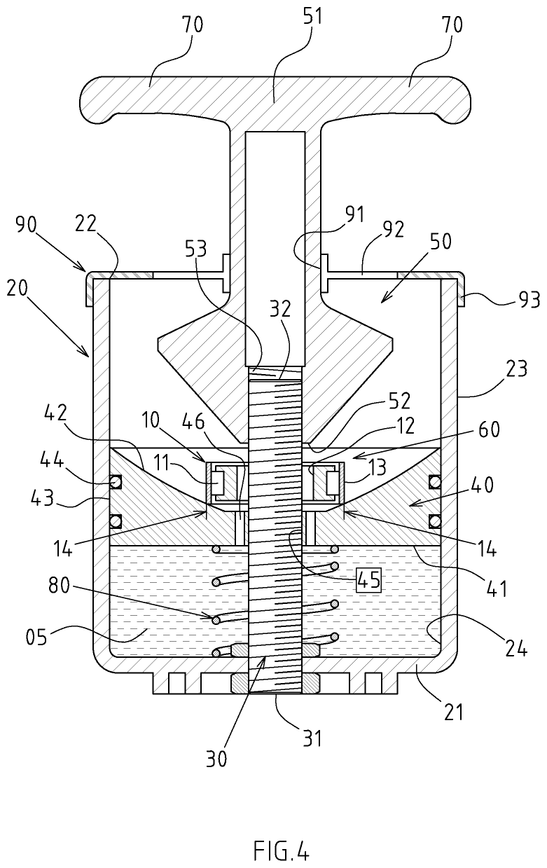

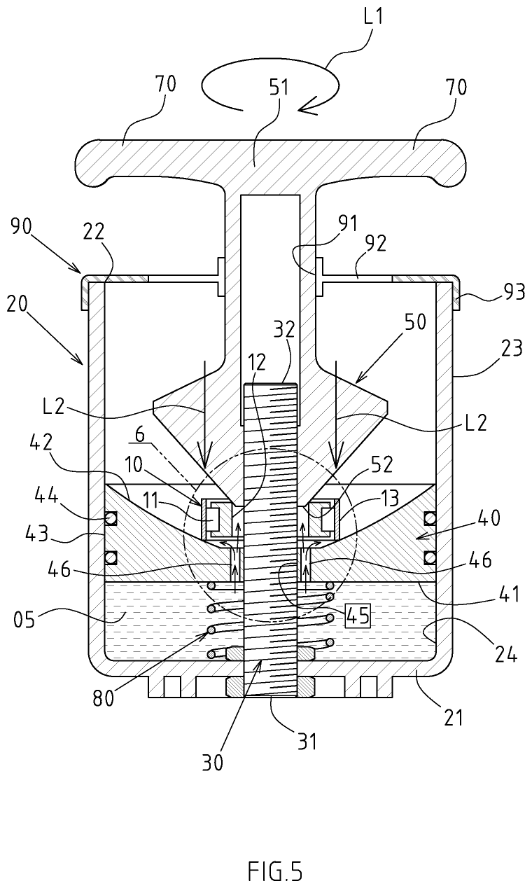

The bearing placement portion 60 is defined and formed by the space between the lower end pressing portion 52 of the pressing base 50 and the bearing surface 42 of the piston 40. The bearing placement portion 60 is for placement of the bearing 10. As shown in FIG. 5, the lower end pressing portion 52 of the pressing base 50 presses downward and seals the axle hole 12 of the bearing 10. The external frame 13 of the bearing presses downward on the bearing surface 42 of the piston 40, and defines and forms a closed lubricating margin 14 (only indicated in FIG. 4).

The rotation driving component 70 is configured on the upper end bearing portion 51 of the pressing base 50. The rotation driving component 70 can rotate when the user applies a force, and can drive the pressing base 50 to rotate and move up and down.

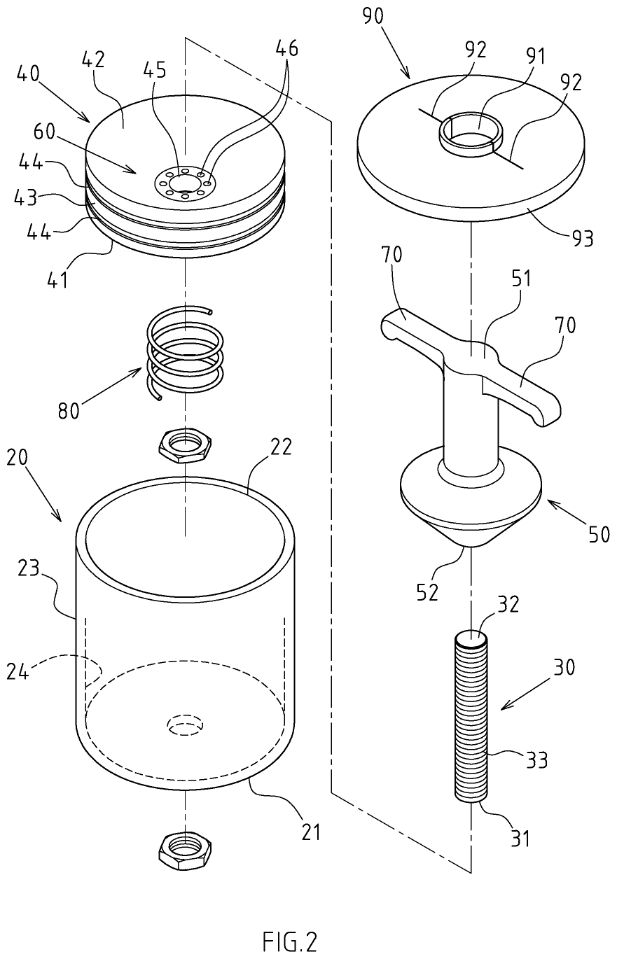

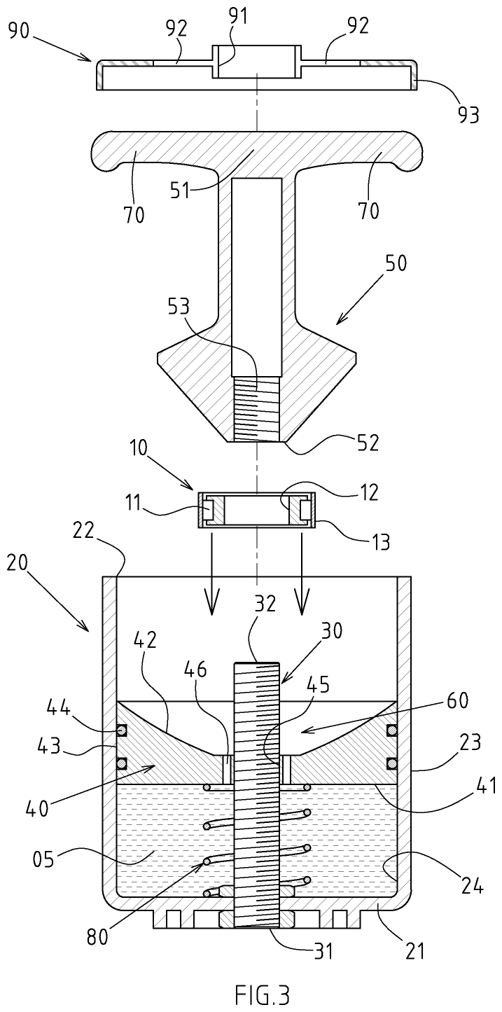

Referring to FIGS. 2 and 3, in the present embodiment, the bearing surface 42 of the piston 40 is configured in the shape of a bell mouth, with its upper end diameter larger than its lower end diameter. Alternatively, it can be configured in a shape with a horizontal plane surface (not shown in the figure). In the present embodiment, the bearing surface 42 is configured in the shape of a bell mouth to meet diversified outer diameters of the bearing products to be processed by the lubricating can and different shapes of the surface in the axial direction. As the bearing surface 42 is configured in the shape of a bell mouth, when the shape of the surface in the axial direction of the bearing product is protruding, i.e., the position of the axle hole 12 is convex, the external frame 13 of the bearing can still press tightly against the bearing surface 42 to form the afore-mentioned ring-shaped closed lubricating margin 14 (only indicated in FIG. 4). In other words, if the bearing products to be processed all have their surface shape in the axial direction with the external frame 13 being higher, even if the bearing surface 42 is configured in a shape with a horizontal plane surface, the formation of the afore-mentioned lubricating margin 14 is not affected.

Referring to FIGS. 1 to 3, in the present embodiment, the rotation driving component 70 is configured in the shape of a lever. The lever and the upper end bearing portion 51 of the pressing base 50 can be formed integrally or separately, without no limitation. Moreover, the rotation driving component 70 can also be shaped as any of a knob or a tool-driven part (such as a groove or a convex block) (not shown in the figure).

Referring to FIGS. 2 and 3, in the present embodiment, an elastic supporting component 80 (can be, but not limited to, a spiral spring) is configured between the pressing surface 41 of the piston 40 and the cup bottom 21 of the grease cup 20. When the piston 40 is pressed to the lowest point, because of the sticky lubricating grease 05 and the vacuum suction, it may become difficult to take out. With the feature disclosed in the present embodiment, the elastic supporting component 80 can help push the piston 40 upward to be released from the sticky grease and the vacuum suction. Thus, the piston 40 can be taken out more easily.

Referring to FIGS. 1 to 5, the cup mouth 22 of the grease cup 20 is further installed with a dust cap 90, which is made of a transparent soft material (such as silicone). The center of the dust cap 90 is formed with a covering mouth 91 to cover the upper end bearing portion 51 of the pressing base 50. The side of the covering mouth 91 is formed with at least one transverse sectional slit 92 extending outward. Moreover, the periphery of the dust cap 90 is formed with a skirt edge 93 bending downward, so as to cover and fit the periphery of the cup mouth 22. The benefit of adding the dust cap 90 of a transparent and soft material in the present embodiment is that it can effectively prevent foreign dust and objects to go into the grease cup 20 from the open cup mouth 22. Thus, it can offer a dust-proof effect. The benefit of using a transparent material is that the user can clearly see the state of the bearing 10 and piston 40 inside the grease cup 20 to control the lubricating operation. The shape of the sectional slit 92 makes it possible for the covering mouth 91 to be enlarged under a force applied by the user, so that the dust cap 90 can be sheathed onto the pressing base 50 from the rotation driving component 70 above in the shape of large lever. Obviously, if the rotation driving component 70 is detachable, the sectional slit 92 will not be necessary.

Based on the above structural constitution and technical characteristics, the real application of the lubricating can disclosed in the present invention is as follows: firstly, as shown in FIG. 3, the user shall fill lubricating grease 05 into the lubricating trough 24 of the grease cup 20; then, place the piston 40 into the lubricating trough 24 and seal it above the lubricating grease 05; meanwhile, the extension end 32 of the bolt 30 goes upward through the through hole 45 configured in the center of the piston 40; then, let the axle hole 12 of the bearing 10 go through the bolt 30 from the extension end 32 till the external frame 13 of the bearing 10 is pressed against the bearing surface 42 of the piston 40; next, fit the screw hole 53 formed on the lower end pressing portion 52 of the pressing base 50 downward to the guiding threads 33 (see FIG. 4) formed on the bolt 30, till the lower end pressing portion 52 presses downward and seals on the axle hole 12 of the bearing 10. In this state, the lubricating operation can be conducted. Referring to FIG. 5, when the user operates the rotation driving component 70 to continuously drive the pressing base 50 to rotate clockwise (as indicated by Arrow L1) to cause the pressing base 50 to move continuously downward (as indicated by Arrow L2), the bearing 10 and piston 40 located below will be pressed to move downward. At this time, the lubricating grease 05 held inside the lubricating trough 24 is squeezed to go upward from the plurality of lubricating guide holes 46 formed on the piston 40, and is introduced into the corresponding axle hole 12 and the roller unit 11 structure of the bearing 10 located above. By now, the lubricating operation is completed. Then, the user shall turn the pressing base 50 counter-clockwise to allow it to rise, detach it from the bolt 30, and resume it to the state shown in FIG. 3. Thus, the bearing 10 filled with lubricating grease 05 can be taken out.

We claim:

1. A lubricating can, specially designed to help a user to inject lubricating grease into the roller unit of a bearing, said bearing having an axle hole and an external frame, the lubricating can comprising a grease cup, a bolt, a piston, a pressing base, a bearing placement portion and a rotation driving component; wherein:
the grease cup has a closed cup bottom, an open cup mouth and a cylindrical inner wall between the cup bottom and the cup mouth, a lubricating trough is defined and formed inside the grease cup, and the lubricating trough is used to hold the lubricating grease;
the bolt is fixed inside the lubricating trough; the bolt has a fixed end and an extension end, wherein the fixed end is connected and fixed in the center of the cup bottom, and the extension end extends toward the cup mouth for a preset length; the bolt is formed with guiding threads;
the piston is housed inside the lubricating trough, capable of moving up and down under a force; the piston has a pressing surface and a bearing surface opposite each other, and a lateral ring surface connecting the peripheries of the pressing surface and the bearing surface; in particular, the bearing surface faces upward toward the cup mouth, and the pressing surface faces downward toward the cup bottom; the pressing surface is to press the lubricating grease held in lubricating trough; the lateral ring surface is configured with at least one ring seal; the at least one ring seal and the cylindrical inner wall are pressed against each other in a slidable fashion; the center of the piston is formed with a through hole that goes through the pressing surface and the bearing surface; the through hole is sheathed on the bolt from the extension end of the bolt, and the through hole fits the bolt loosely, so that, relatively, the piston is not driven by the bolt; the piston is formed with a plurality of lubricating guide holes on the periphery of the through hole lined up in a circle with intervals; a plurality of lubricating guide holes goes through the pressing surface and the bearing surface;
the pressing base comprises an upper end bearing portion and a lower end pressing portion, wherein, in the center of the lower end pressing portion, a screw hole is formed upward; the screw hole fits the guiding threads formed on the bolt; the lower end pressing portion faces the bearing surface of the piston; the upper end bearing portion is located above the cup mouth of the grease cup;
the bearing placement portion is defined and formed by the space between the lower end pressing portion of the pressing base and the bearing surface of the piston; the bearing placement portion is for placement of the bearing; the lower end pressing portion of the pressing base presses downward and seals the axle hole of the bearing; the external frame of the bearing presses downward on the bearing surface of the piston, and defines and forms a closed lubricating margin; and
the rotation driving component is configured on the upper end bearing portion of the pressing base; the rotation driving component can rotate when the user applies a force, and can drive the pressing base to rotate and move up and down.

2. The lubricating can defined in claim 1, wherein the bearing surface of the piston is configured in the shape of a bell mouth, with its upper end diameter larger than its lower end diameter.

3. The lubricating can defined in claim 1, wherein the rotation driving component is configured in the shape of a lever.

4. The lubricating can defined in claim 1, wherein, an elastic supporting component is configured between the pressing surface of the piston and the cup bottom of the grease cup.

5. The lubricating can defined in claim 1, wherein the cup mouth of the grease cup is installed with a dust cap, which is made of a transparent soft material; the center of the dust cap is formed with a covering mouth to cover the upper end bearing portion of the pressing base; the side of the covering mouth is formed with at least one transverse sectional slit extending outward; the periphery of the dust cap is formed with a skirt edge bending downward, so as to cover and fit the periphery of the cup mouth.
